(19) United States
(12) Patent Application Publication
(10) Pub. No.: US 2026/0219100 A1
(43) Pub. Date: Jul. 30, 2026

(54) ACOUSTIC FEATURE COMPUTING APPARATUS, ACOUSTIC FEATURE COMPUTING METHOD, AND PROGRAM

(71) Applicant: NTT, INC., Tokyo (JP)

(72) Inventors: Kenji ISHIKAWA, Musashino-shi, Tokyo (JP); Takehiro MORIYA, Musashino-shi, Tokyo (JP); Yoshifumi SHIRAKI, Musashino-shi, Tokyo (JP)

(73) Assignee: NTT, Inc., Tokyo (JP)

(21) Appl. No.: 19/146,988

(22) PCT Filed: Jan. 27, 2023
(86) PCT No.: PCT/JP2023/002681

§ 371 Date: Jul. 10, 2025

(51) Int. Cl. G01H 9/00; H04R 29/00

(52) U.S. Cl. CPC G01H 9/00; H04R 29/00

(57) ABSTRACT

A technique is provided for measuring acoustic characteristics of a parametric speaker having any shape and characteristics. An acoustic characteristics calculation device includes a measurement data acquisition unit that acquires a set of a phase change amount φ_{q} of light due to radiated sound of a parametric speaker obtained in q-th measurement by an optical measurement device and a parameter ρ_{q} that characterizes an optical path L_{q} in the measurement (q=1, 2, . . . , Q), and a sound field calculation unit that calculates a sound pressure at a point in a sound field that is generated by the radiated sound of the parametric speaker from the set of the phase change amount φ_{q} and the parameter ρ_{q} (q=1, 2, . . . , Q).

### TECHNICAL FIELD

The present invention relates to a technique for measuring acoustic characteristics of a parametric speaker.

### BACKGROUND ART

A parametric array is a nonlinear acoustic phenomenon in which sound is generated in a space due to nonlinearity of a medium. Specifically, a parametric array is a phenomenon in which, when sound having two different frequencies propagates, nonlinear sound having a frequency represented by the difference between the frequencies is generated. A parametric speaker that reproduces audible sound using this phenomenon is used for reproduction of sound in a limited space, spatial sound representation technologies, noise control, and the like.

It is known that when measuring the radiated sound of a parametric speaker using a microphone, a noise called onomatopoeia is generated, and the radiated sound to be measured and the onomatopoeia are superimposed, resulting in the two being detected in an indistinguishable form.

Therefore, Non Patent Literature 1 proposes a method for measuring the radiated sound of a parametric speaker using light. Specifically, the Gaussian beam expansion method is used to restore the sound pressure at a point on a laser optical path from the line integral value of the radiated sound of a parametric speaker measured by light along the optical path. According to the method described in Non Patent Literature 1, it is possible to accurately measure radiated sound without producing onomatopoeia.

### CITATION LIST

### Non Patent Literature

Non Patent Literature 1: Kenji Ishikawa, Yoshifumi Shiraki, and Takehiro Moriya, “Spurious-sound-free measurement of parametric acoustic array using optical interferometry,” JASA Express Letters 1, 112801, 2021.

### SUMMARY OF INVENTION

### Technical Problem

However, the Gaussian beam expansion method can be applied only to parametric speakers that have a simple shape, such as a circular shape, and that satisfy the properties of a piston sound source, such as when all elements of the parametric speaker are driven in phase. Therefore, the number of parametric speakers whose acoustic characteristics can be measured using the method described in Non Patent Literature 1 is limited.

Therefore, an object of the present invention is to provide a technique for measuring acoustic characteristics of a parametric speaker having any shape and characteristics.

### Solution to Problem

An aspect of the present invention includes: assuming that Q is an integer equal to or greater than 2 and L_{q} (q=1, 2, . . . , Q) is an optical path in q-th measurement by an optical measurement device that measures a phase change of light due to radiated sound of a parametric speaker that is an object of acoustic characteristics measurement, a measurement data acquisition unit configured to acquire a set of a phase change amount φ_{q} of light due to the radiated sound of the parametric speaker obtained in the q-th measurement by the optical measurement device and a parameter ρ_{q} that characterizes the optical path L_{q} in the measurement (q=1, 2, . . . , Q); and a sound field calculation unit configured to calculate a sound pressure at a point in a sound field that is generated by the radiated sound of the parametric speaker from the set of the phase change amount ρ_{q} and the parameter ρ_{q} (q=1, 2, . . . , Q).

### Advantageous Effects of Invention

According to the present invention, it is possible to measure acoustic characteristics of a parametric speaker having any shape and characteristics.

### BRIEF DESCRIPTION OF DRAWINGS

FIG. 1 is a diagram illustrating an example of a configuration of an optical measurement device 800 and a state of measurement by the optical measurement device 800.

FIG. 2 is a block diagram illustrating a configuration of an acoustic characteristics calculation device 100.

FIG. 3 is a flowchart illustrating an operation of the acoustic characteristics calculation device 100.

FIG. 4 is a block diagram illustrating a configuration of a sound field calculation unit 120.

FIG. 5 is a flowchart illustrating an operation of the sound field calculation unit 120.

FIG. 6 is a diagram illustrating an example of a functional configuration of a computer that implements each device according to an embodiment of the present invention.

### DESCRIPTION OF EMBODIMENTS

Hereinafter, an embodiment of the present invention will be described in detail. Note that components having the same function are denoted by the same number, and redundant description will be omitted.

A notation method used in this specification will be described before the embodiments are described.

The “\hat{ }” (caret) represents a superscript. For example, x^{y\hat{ }z} represents that y^{z} is a superscript for x, and x_{y\hat{ }z} represents that y^{z} is a subscript for x. Further, the underscore (_) represents a subscript. For example, x^{y\hat{ }z} represents that y_{z} is a superscript for x, and x_{y\hat{ }z} represents that y_{z} is a subscript for x.

A superscript “\hat{ }” or “~” such as \hat{ }x or ~x for a certain character x would normally be placed directly above “x”, but is written as \hat{ }x or ~x due to restrictions of notation in the specification.

### TECHNICAL BACKGROUND

First, a sound field measurement method using a change in the refractive index of a medium caused by sound called the acousto-optic effect (see Reference Non Patent Literature 1) will be described. According to the acousto-optic effect, a phase change amount φ of light due to sound is expressed by the following equation.

$$\begin{matrix}[ Math . 1 ] & \\ ϕ = {k}_{light} \frac{{n}_{0} - 1}{γ {p}_{0}} {\int }_{L} pdx & ( 1 )\end{matrix}$$

Here, k_{light} is a wave number of light, nₒ is a refractive index of air in a steady state, pₒ is atmospheric pressure in a steady state, and γ is a specific heat ratio of air. Also, the sound pressure p is a sound pressure at a certain point in the sound field at a certain time. The integral in Equation (1) represents a line integral of the sound pressure p along a light propagation path (hereinafter referred to as an optical path) L. Note that k_{light}, nₒ, pₒ, and γ are constants determined from physical conditions at the time of the measurement.

(Reference Non Patent Literature 1: Kenji Ishikawa, Kohei Yatabe, Nachanant Chitanont, Yusuke Ikeda, Yasuhiro Oikawa, Takashi Onuma, Hayato Niwa, and Minoru Yoshii, “High-speed imaging of sound using parallel phase-shifting interferometry,” Optics Express, Vol. 24, Issue 12, pp. 12922-12932, 2016.)

As can be seen from Equation (1), the phase change amount p of light due to the sound is not an amount representing the sound pressure at a point in the sound field, but an amount proportional to the line integral value of the sound pressure along the optical path L. In the above-mentioned sound field measurement method, the sound field is measured by measuring the phase change amount of light due to this sound.

In an embodiment of the present invention, in order to obtain the sound pressure at a point in a sound field generated by the radiated sound of a parametric speaker having any shape and characteristics, synchronous measurements are executed a plurality of times by translation scanning and rotation scanning the parametric speaker and the optical measurement device to obtain a plurality of pieces of measurement data. The measurement data obtained by the synchronous measurement is the phase change amount of light due to the radiated sound of the parametric speaker, and the values of parameters that characterize the optical path in measuring the phase change amount are also acquired. Using the obtained sets of the plurality of phase change amounts and values of parameters, the sound pressure at a point in the sound field that is generated by the radiated sound of the parametric speaker is calculated.

The sound pressure can be calculated using optimization calculations based on the physical equations of sound (see Reference Non Patent Literature 2 and Reference Non Patent Literature 3).
(Reference Non Patent Literature 2: Kohei Yatabe, Kenji Ishikawa and Yasuhiro Oikawa, “Acousto-optic back-projection: Physical-model-based sound field reconstruction from optical projections,” Journal of Sound and Vibration, vol. 394, pp. 171-184, 2017.)
(Reference Non Patent Literature 3: Samuel A. Verburg and Efren Fernandez-Grande, “Acousto-Optical Volumetric Sensing of Acoustic Fields,” Physical Review Applied 16, 044033, 2021.)

### <<1: Optimization Calculation Based on Reference Non Patent Literature 2>>

In general, sound pressure p(x, t) (where x represents position and t represents time) follows the wave equation.

$$\begin{matrix}[ Math . 2 ] & \\ ( Δ - \frac{1}{{c}^{2}} \frac{{\partial }^{2}}{\partial {t}^{2}} ) p ( x , t ) = 0 & ( 2 )\end{matrix}$$

Here, Δ represents Laplacian, and c represents a sound speed.

By Fourier transforming Equation (2), the Helmholtz equation satisfied by the sound pressure u(x, ω) (where x represents position and w represents angular frequency) in the frequency domain is obtained.

$$\begin{matrix}[ Math . 3 ] & \\ ( Δ + {k}^{2} ) u ( x , ω ) = 0 & ( 3 )\end{matrix}$$

Here, k=ω/c, which represents a wave number.

Therefore, the line integral value d of the sound pressure in the frequency domain along the optical path L calculated by the following equation can be obtained from the phase change amount cp, which is the measurement data (see Equations (1), (2), and (3)).

$$\begin{matrix}[ Math . 4 ] & \\ d = {\int }_{L} u d x & ( 4 )\end{matrix}$$

Here, similarly to the normal CT method, the optical path L is characterized by the following equation (see Reference Non Patent Literature 4).

$$\begin{matrix}[ Math . 5 ] & \\ {χ}_{μ}^{θ} ( η ) = μ ( cos ( θ ) , sin ( θ ) , 0 ) + η ( - sin ( θ ) , cos ( θ ) , 0 ) & ( 5 )\end{matrix}$$

Here, μ, θ, and η represent a distance from the origin of the optical path L, a rotation angle around the origin of the optical path L, and a position on the optical path L, respectively.
(Reference Non Patent Literature 4: T. G. Feeman, “The Mathematics of Medical Imaging,” Springer 2015.)

Then, Equation (4) can be expressed by the following equation.

$$\begin{matrix}[ Math . 6 ] & \\ d = {\int }_{- r}^{r} u ( {χ}_{μ}^{θ} ( η ) ) d η & ( 6 )\end{matrix}$$

Here, r represents half the length of the line integral path along the optical path L.

In the following, in order to calculate the sound pressure at a point in the sound field generated by the radiated sound of the parametric speaker, the sound pressure u that satisfies Equation (3) is approximated by the Herglotz wave function of the following equation.

$$\begin{matrix}[ Math . 7 ] & \\ u ( x ) = {\int }_{{S}^{2}} g ( v ) {e}^{ik 〈 x , y 〉} dv & ( 7 )\end{matrix}$$

Here, S² represents a unit sphere, g(ν) represents a Herglotz kernel, i represents an imaginary unit, and <a, b> represents an inner product of vector a and vector b.

Here, the Herglotz kernel g can be expanded using spherical harmonic functions Yₙ^{m} (n=0, 1, . . . , m=−n, −n−1, . . . , n−1, n) as in the following equation.

$$\begin{matrix}[ Math . 8 ] & \\ g = {{\sum }_{n = 0}}^{∞} {{\sum }_{m = - n}}^{n} {α}_{n}^{m} {Y}_{n}^{m} & ( 8 )\end{matrix}$$

Here, αₙ^{m} (n=0, 1, . . . , m=−n, −n−1, . . . , n−1, n) are expansion coefficients.

By using Equations (7) and (8), Equation (4) becomes the following equation.

$$\begin{matrix}[ Math . 9 ] & \\ d = {{\sum }_{n = 0}}^{∞} {{\sum }_{m = - n}}^{n} {α}_{n}^{m} {γ}_{r , n}^{μ , θ , m} & ( 9 )\end{matrix}$$

Here, γ_{r,n}^{μ,θ,m} (n=0, 1, . . . , m=−n, −n−1, . . . , n−1, n) are expressed by the following equation.

$$\begin{matrix}[ Math . 10 ] & \\ {γ}_{r , n}^{μ , θ , m} = 2 r {\int }_{0}^{2 π} {\int }_{0}^{π} {Y}_{n}^{m} ( α , β ) s i n c ( k r sin ( α ) sin ( β - θ ) ) {e}^{ik μ sin ( α ) cos ( β - θ )} sin ( α ) d α d β & ( 10 )\end{matrix}$$

$$\begin{matrix}[ Math . 11 ] & \\ sinc ( x ) = \{ \begin{matrix}\frac{sin ( x )}{x} & ( x \neq 0 ) \\ 1 & ( x = 0 )\end{matrix} & ( 11 )\end{matrix}$$

Here, as can be seen from Equation (10), γ_{r,n}^{μ,θ,m} is a quantity that depends only on the distance p, the rotation angle θ, and the length r. Note that γ_{r,n}^{μ,θ,m} in a case where n-m is an odd number.

Hereinafter, it is assumed that γ_{r,n}^{μ,θ,m} (s=1, 2, . . . ) is the sequence of γ_{r,n}^{μ,θ,m} (n=0, 1, . . . , m=−n, −n−2, . . . , n−2, n) arranged in ascending order of n, that is, the sequence of γ_{r,n}^{μ,θ,m} (n=0, 1, . . . , m=−n, −n−1, . . . , n−1, n) arranged in ascending order of n, excluding the combinations of n and m where n-m is odd. Therefore, γ_{r,n}^{μ,θ,m} (s=1, 2, . . . ) is γ_{r,0}^{μ,θ,0}, γ_{r,1}^{μ,θ,-1}, γ_{r,1}^{μ,θ,1}, γ_{r,2}^{μ,θ,-2}, γ_{r,n}^{μ,θ,0}, γ_{r,2}^{μ,θ,2}, γ_{r,3}^{μ,θ,-3}, γ_{r,3}^{μ,θ,-1}, γ_{r,3}^{μ,θ,1}, γ_{r,3}^{μ,θ,3},γ_{r,4}^{μ,θ,-4}, γ_{r,4}^{μ,θ,-2}, . . . .

Here, it is considered that Equation (9) is approximated by the finite sum of the following equation.

$$\begin{matrix}[ Math . 12 ] & \\ d = {\sum }_{s = 1}^{S} {α}_{s} {γ}_{r , s}^{μ , θ} & ( 12 )\end{matrix}$$

Here, S is a predetermined positive integer.

When Q (where Q is an integer equal to or greater than 2) is the number of measurements, L_{q} (q=1, 2, . . . , Q) is the optical path in the q-th measurement, d_{q} (q=1, 2, . . . , Q) is the sound pressure corresponding to the phase change amount Cg obtained in the q-th measurement, μ_{q} (q=1, 2, . . . , Q) is the distance from the origin of the optical path L_{q} in the q-th measurement, θ_{q} (q=1, 2, . . . , Q) is the rotation angle around the origin of the optical path L_{q} in the q-th measurement, and r_{q} (q=1, 2, . . . , Q) is half the length of the line integral path along the optical path L_{q} in the q-th measurement, the following equation is obtained by Q synchronous measurements.

$$\begin{matrix}[ Math . 13 ] & \\ {d}_{q} = {\sum }_{s = 1}^{S} {α}_{s} {γ}_{{r}_{q} , s}^{{μ}_{q} , {θ}_{q}} ( q = 1 , 2 , … , Q ) & ( 13 )\end{matrix}$$

Note that μ_{q}, θ_{q}, and r_{q} are a parameter ρ_{q} that characterizes the optical path L_{q} in the q-th measurement.

When ~d is a Q-dimensional column vector with d_{q} (q=1, 2, . . . , Q) as its q-th element, ~γ is a Q×S matrix with γ_{r,n}^{μ,θ,m} (q=1, 2, . . . , Q, s=1, 2, . . . , S) as its (q, s)-th element, and ~α is an S-dimensional column vector with αₛ (s=1, 2, . . . , S) as its s-th element, Equation (13) can be expressed as follows.

$$\begin{matrix}[ Math . 14 ] & \\ \tilde{d} = \tilde{γ} \tilde{a} & ( 14 )\end{matrix}$$

In order to calculate the sound pressure at a point in the sound field generated by the radiated sound of the parametric speaker, first, the optimal value α*=(α₁*, α₂*, . . . , αₛ*) of ~α=(α₁, α₂, . . . , αₛ) that satisfies Equation (14) is obtained using the following equation.

$$\begin{matrix}[ Math . 15 ] & \\ {a}^{*} = arg {min}_{\tilde{α}} {‖ \tilde{d} - \tilde{γ} \tilde{α} ‖}_{2}^{2} & ( 15 )\end{matrix}$$

Then, using the optimal value α*=(α₁*, α₂*, . . . , αₛ*), the sound pressure u at a point x in the sound field generated by the radiated sound of the parametric speaker is calculated using Equation (7) and the following equation.

$$\begin{matrix}[ Math . 16 ] & \\ g = {\sum }_{s = 1}^{S} {α}_{s} {Y}_{s} & ( 16 )\end{matrix}$$

Here, Yₛ (s=1, . . . , S) is a sequence of functions obtained by arranging S spherical harmonic functions Yₙ^{m} (n=0, 1, . . . , m=−n, −n−2, . . . , n−2, n) in ascending order of n.

### <<2: Optimization Calculation Based on Reference Non Patent Literature 3>>

As can be seen from Equation (1), the line integral value σ of the sound pressure in the time domain along the optical path L calculated by the following equation can be obtained from the phase change amount cp, which is the measurement data.

$$\begin{matrix}[ Math . 17 ] & \\ σ = {\int }_{L} p d x & ( 17 )\end{matrix}$$

In the following, in order to calculate the sound pressure at a point in the sound field generated by the radiated sound of the parametric speaker, the line integral value σ of Equation (17) is approximated by the following expansion equation.

$$\begin{matrix}[ Math . 18 ] & \\ σ = {\sum }_{s = 1}^{S} {a}_{s} {\int }_{L} {e}^{i 〈 {k}_{s} , x 〉} dx & ( 18 )\end{matrix}$$

Here, S is a predetermined positive integer, aₛ (s=1, 2, . . . , S) is an expansion coefficient, and kₛ (s=1, 2, . . . , S) represents a wave number vector indicating a propagation direction of an s-th wave.

When Q (where Q is an integer equal to or greater than 2) is the number of measurements, L_{q} (q=1, 2, . . . , Q) is the optical path in the q-th measurement, σ_{q} (q=1, 2, . . . , Q) is the sound pressure corresponding to the phase change amount φ_{q} of light obtained in the q-th measurement, and ρ_{q} (q=1, 2, . . . , Q) is a parameter that characterizes the optical path L_{q} in the q-th measurement, the following equation is obtained by Q synchronous measurements.

$$\begin{matrix}[ Math . 19 ] & \\ {σ}_{q} = {\sum }_{s = 1}^{S} {a}_{s} {h}_{q , s} ( q = 1 , 2 , … , Q ) & ( 19 )\end{matrix}$$

Here, h_{q,s} (q=1, 2, . . . , Q, s=1, 2, . . . , S) is calculated using the following equation.

$$\begin{matrix}[ Math . 20 ] & \\ {h}_{q , s} = {\int }_{{L}_{q}} {e}^{i < {k}_{s} , x >} dx & ( 20 )\end{matrix}$$

As the parameter ρ_{q} used to calculate the line integral value of Equation (20), μ_{q} and θ_{q} described in <<1: Optimization Calculation Based on Reference Non Patent Literature 2>> can be used.

When ~σ is a Q-dimensional column vector with σ_{q} (q=1, 2, . . . , Q) as its q-th element, H is a Q×S matrix with h_{q,s} (q=1, 2, . . . , Q, s=1, 2, . . . , S) as its (q, s)-th element, and ~a is an S-dimensional column vector with aₛ (s=1, 2, . . . , S) as its s-th element, Equation (19) can be expressed as follows.

$$\begin{matrix}[ Math . 21 ] & \\ \tilde{σ} = H \tilde{a} & ( 21 )\end{matrix}$$

In order to calculate the sound pressure at a point in the sound field generated by the radiated sound of the parametric speaker, first, the optimal value a*=(a₁*, a₂*, . . . , aₛ*) of ~a=(a₁, a₂, . . . , aₛ) that satisfies Equation (21) is obtained using the following equation.

$$\begin{matrix}[ Math . 22 ] & \\ {a}^{*} = arg {min}_{\tilde{a}} {‖ \tilde{a} ‖}_{2} subject to {‖ \tilde{σ} - H \tilde{a} ‖}_{2} \leq ε & ( 22 )\end{matrix}$$

Here, ε represents a predetermined positive number indicating an allowable error.

Then, when x₁, . . . , x_{J} are the J points in the sound field for which the sound pressure is to be calculated, using the optimal value a*=(a₁*, a₂*, . . . , aₛ*), the sound pressures p₁, . . . , p_{J} at points x₁, . . . , x_{J} in the sound field generated by the radiated sound of the parametric speaker are calculated using the following equation.

$$\begin{matrix}[ Math . 23 ] & \\ \tilde{p} = G \tilde{a} & ( 23 )\end{matrix}$$

Here, ~p represents a J-dimensional column vector with p_{J} (j=1, 2, . . . , J) as its j-th element, G represents a J×S matrix with g_{j,s} (j=1, 2, . . . , J, s=1, 2, . . . , S) as its (j, s)-th element in the following equation, and ~a represents an S-dimensional column vector with aₛ* (s=1, 2, . . . , S) as its s-th element.

$$\begin{matrix}[ Math . 24 ] & \\ {g}_{j , s} = {e}^{i < {k}_{s} , {x}_{j} >} & ( 24 )\end{matrix}$$

### First Embodiment

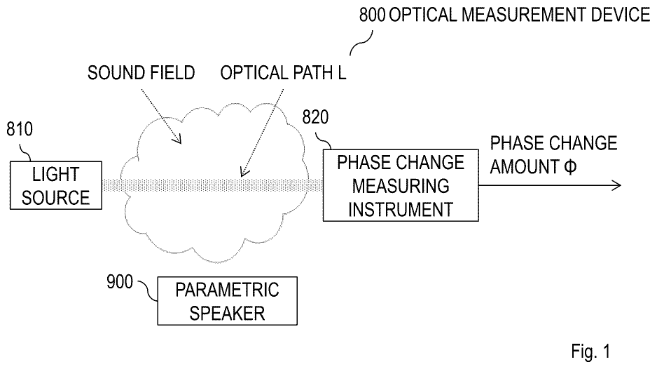

An acoustic characteristics calculation device 100 uses the phase change amount of light due to sound, which is an output of an optical measurement device 800, to calculate a sound pressure at a point in a sound field that is generated by radiated sound of a parametric speaker 900 which is an object of acoustic characteristics measurement. Thus, first, the optical measurement device 800 will be described with reference to FIG. 1.

FIG. 1 is a diagram illustrating an example of a configuration of the optical measurement device 800 and a state of measurement by the optical measurement device 800. As illustrated in FIG. 1, the optical measurement device 800 includes a light source 810 and a phase change measuring instrument 820. Here, the parametric speaker 900 may be a parametric speaker having any shape and characteristics. Furthermore, the optical measurement device 800 measures the acoustic characteristics of the parametric speaker 900, that is, the phase change amount of light due to the radiated sound of the parametric speaker 900 used to obtain the sound pressure at a point in the sound field that is generated by the radiated sound. The optical measurement device 800 may be any device capable of measuring the phase change amount. As illustrated in FIG. 1, the optical path L is set to pass through a sound field that is generated by the radiated sound of the parametric speaker 900.

Hereinafter, an operation of the optical measurement device 800 will be described. First, the parametric speaker 900 generates radiated sound and creates a sound field. Next, the light source 810 emits light. The light emitted from the light source 810 is subjected to phase modulation by the sound as the light passes through the sound field. The light subjected to the phase modulation by the sound is input to the phase change measuring instrument 820, a change occurs in the amount of the light depending on the amount of the phase modulation by the phase change measuring instrument 820, and the phase change measuring instrument 820 measures and outputs the distribution of the changed light amount, that is, the phase change amount of the light due to the radiated sound. The above-described operation is considered as one measurement by the optical measurement device 800, and the measurement by the optical measurement device 800 is repeatedly executed a plurality of times while changing the positional relationship between the optical measurement device 800 and the parametric speaker 900 so as to scan the sound field, which is the measurement area. For example, a moving device (not illustrated) translates or rotates one or both of the optical measurement device 800 and the parametric speaker 900, thereby changing the relative positional relationship between the parametric speaker 900 and the optical measurement device 800.

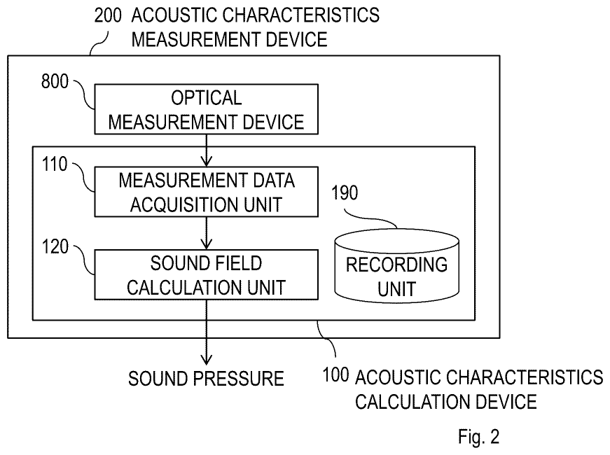

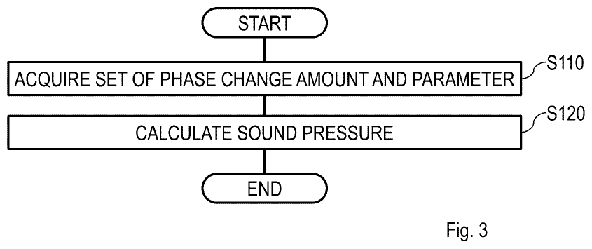

Hereinafter, the acoustic characteristics calculation device 100 will be described with reference to FIGS. 2 and 3. FIG. 2 is a block diagram illustrating a configuration of the acoustic characteristics calculation device 100. FIG. 3 is a flowchart illustrating an operation of the acoustic characteristics calculation device 100. As illustrated in FIG. 2, the acoustic characteristics calculation device 100 includes a measurement data acquisition unit 110, a sound field calculation unit 120, and a recording unit 190. The recording unit 190 is a component that appropriately records information necessary for processing of the acoustic characteristics calculation device 100. Further, the device including the optical measurement device 800 and the acoustic characteristics calculation device 100 is referred to as an acoustic characteristics measurement device 200.

In the following, it is assumed that the acoustic characteristics measurement device 200 executes measurement Q times (where Q is an integer greater than or equal to 2) using the optical measurement device 800, and L_{q} (q=1, 2, . . . , Q) is the optical path in the q-th measurement by the optical measurement device 800 that measures the phase change of light due to the radiated sound of the parametric speaker 900, which is an object of acoustic characteristics measurement.

The operation of the acoustic characteristics calculation device 100 will be described with reference to FIG. 3.

In S110, the measurement data acquisition unit 110 acquires a set of the phase change amount φ_{q} of light due to the radiated sound of the parametric speaker 900 obtained in the q-th measurement by the optical measurement device 800 and a parameter ρ_{q} that characterizes the optical path L_{q} in that measurement (q=1, 2, . . . , Q).

In S120, the sound field calculation unit 120 calculates the sound pressure at a point in the sound field that is generated by the radiated sound of the parametric speaker 900, from the set of the phase change amount φ_{q} and the parameter ρ_{q} (q=1, 2, . . . , Q) acquired in S110.

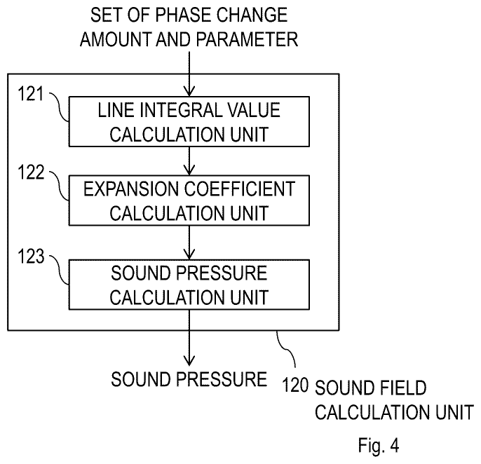

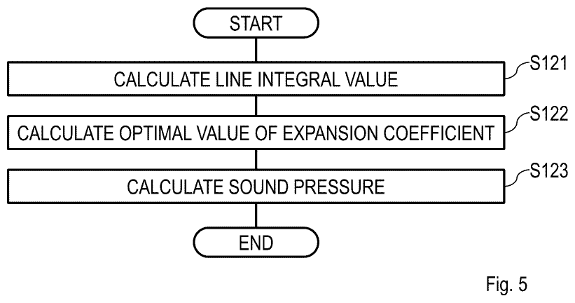

Hereinafter, the sound field calculation unit 120 will be described with reference to FIGS. 4 and 5. FIG. 4 is a block diagram illustrating a configuration of the sound field calculation unit 120. FIG. 5 is a flowchart illustrating an operation of the sound field calculation unit 120. As illustrated in FIG. 4, the sound field calculation unit 120 includes a line integral value calculation unit 121, an expansion coefficient calculation unit 122, and a sound pressure calculation unit 123.

The operation of the sound field calculation unit 120 will be described with reference to FIG. 5. The sound field calculation unit 120 calculates the sound pressure at a point in the sound field that is generated by the radiated sound of the parametric speaker 900, for example, by executing <<1: Optimization Calculation Based on Reference Non Patent Literature 2>> or <<2: Optimization Calculation Based on Reference Non Patent Literature 3>> described in <Technical Background>.

### Operation Example 1: Optimization Calculation Based on Reference Non Patent Literature 2

In S121, the line integral value calculation unit 121 calculates the line integral value d_{q} (q=1, 2, . . . , Q) of the sound pressure in the frequency domain along the optical path L_{q} from the phase change amount φ_{q} (q=1, 2, . . . , Q) which is an input to the sound field calculation unit 120. The line integral value calculation unit 121 calculates the line integral value d_{q} (q=1, 2, . . . , Q) by, for example, Fourier transforming the phase change amount φ_{q} (q=1, 2, . . . , Q).

In S122, the expansion coefficient calculation unit 122 calculates the optimal value αᵢ* (s=1, 2, . . . , S) of the expansion coefficient as in the expansion equation of the sound pressure u in the frequency domain in the following equations, from a set of the line integral value d_{q} calculated in S121 and the parameter ρ_{q} (q=1, 2, . . . , Q) which is an input to the sound field calculation unit 120.

$$u ( x ) = {\int }_{{S}^{2}} g ( v ) {e}^{ik < x , v >} dv \qquad [ Math . 25 ]$$

$$g = {\sum }_{s = 1}^{S} {α}_{s} {Y}_{s} \qquad [ Math . 26 ]$$

(where S² represents a unit sphere, i represents an imaginary unit, <a, b> represents an inner product of vector a and vector b, k represents a wave number, and Yₛ (s=1, . . . , S) is a sequence of functions obtained by arranging S spherical harmonic functions Yₙ^{m} (n=0, 1, . . . , m=−n, −n−2, . . . , n−2, n) in ascending order of n.)

Note that the parameter ρ_{q} is μ_{q}, θ_{q}, and r_{q} as described in <<1: Optimization Calculation Based on Reference Non Patent Literature 2>> in <Technical Background>, and the expansion coefficient calculation unit 122 calculates the optimal value αₛ* (s=1, 2, . . . , S) by the procedure described in <<1: Optimization Calculation Based on Reference Non Patent Literature 2>> in <Technical Background>, for example.

In S123, the sound pressure calculation unit 123 calculates the sound pressure u(x) at a point x in the sound field according to the expansion equation used in S122 using the optimal value αₛ* (s=1, 2, . . . , S) calculated in S122.

Here, the operation of the measurement data acquisition unit 110 when the optimization calculation based on Reference Non Patent Literature 2 is used will be described. In order to acquire a set of the phase change amount φ_{q} and the parameter ρ_{q} (q=1, 2, . . . , Q), the measurement data acquisition unit 110 controls the moving device to execute a translation scan in at least one direction on a certain plane and a rotation scan about one axis (for example, a scanning in the height direction of the parametric speaker 900 and a rotation of the jig to which the parametric speaker 900 is attached).

When measuring a sound field three-dimensionally, the above-mentioned translation scan and rotation scan need to be repeatedly executed on a plurality of planes parallel to a certain plane P. At this time, a three-dimensional sound field can be obtained by connecting a plurality of two-dimensional sound fields obtained as the output of the sound field calculation unit 120 in a direction perpendicular to the plane P, which is the third dimension.

### Operation Example 2: Optimization Calculation Based on Reference Non Patent Literature 3

In S121, the line integral value calculation unit 121 calculates the line integral value σ_{q} (q=1, 2, . . . , Q) of the sound pressure in the time domain along the optical path L_{q} from the phase change amount φ_{q} (q=1, 2, . . . , Q) which is an input to the sound field calculation unit 120. The line integral value calculation unit 121 calculates the line integral value σ_{q} (q=1, 2, . . . , Q) by, for example, the following equation obtained from Equation (1).

$${σ}_{q} = \frac{1}{{k}_{light}} \frac{γ {p}_{0}}{{n}_{0} - 1} {ϕ}_{q} \qquad [ Math . 27 ]$$

In S122, the expansion coefficient calculation unit 122 calculates the optimal value aₛ* (s=1, 2, . . . , S) of the expansion coefficient aₛ in the expansion equation of the line integral value σ of the sound pressure in the time domain in the following equation, from a set of the line integral value d_{q} calculated in S121 and the parameter ρ_{q} (q=1, 2, . . . , Q) which is an input to the sound field calculation unit 120.

$$σ = {\sum }_{s = 1}^{S} {a}_{s} {\int }_{L} {e}^{i < {k}_{s} , x >} dx \qquad [ Math . 28 ]$$

(where L represents an optical path in the measurement, i represents an imaginary unit, <a, b> represents an inner product of vector a and vector b, and kₛ represents a wave number vector indicating a propagation direction of an s-th wave.)

As described in <<2: Optimization Calculation Based on Reference Non Patent Literature 3>> in <Technical Background>, μ_{q} and θ_{q} can be used for the parameter ρ_{q}.

In S123, the sound pressure calculation unit 123 calculates sound pressures p₁, . . . , p_{J} at points x₁, . . . , x_{J} in the sound field by the following equation using the optimal value aₛ* (s=1, 2, . . . , S) calculated in S122.

$$\tilde{p} = G \tilde{a} \qquad [ Math . 29 ]$$

(where ~p represents a J-dimensional column vector with p_{J} (j=1, 2, . . . , J) as its j-th element, G represents a J×S matrix with g_{j,s} (j=1, 2, . . . , J, s=1, 2, . . . , S) as its (j, s)-th element in the following equation, and ~a represents an S-dimensional column vector with aₛ* (s=1, 2, . . . , S) as its s-th element.)

$${g}_{j , s} = {e}^{i < {k}_{s} , {x}_{j} >} \qquad [ Math . 30 ]$$

Here, the operation of the measurement data acquisition unit 110 when the optimization calculation based on Reference Non Patent Literature 3 is used will be described. Unlike the case where the optimization calculation based on Reference Non Patent Literature 2 is used, the measurement data acquisition unit 110 does not necessarily need to execute a translation scan in one direction on a certain plane and a rotation scan about one axis. The measurement data acquisition unit 110 does not acquire a set of phase change amount φ_{q} and parameter ρ_{q} (q=1, 2, . . . , Q) as data on one plane, but rather acquires them as data on any number of points in three-dimensional space.

Note that, as the optical measurement device 800, a single point measuring instrument that measures the phase change amount, which is a time signal of a line integral value along a single optical path, can be used. An example of a single point measuring instrument is the laser Doppler vibrometer. Furthermore, as the optical measurement device 800, an imaging device using a camera can be used. An example of an imaging device using a camera is a polarization high-speed interferometer. In this case, since the distribution of two-dimensional sound pressure line integral values can be measured as a moving image, the moving device does not necessarily require a linear moving mechanism, but can only have a rotation mechanism along one axis.

According to the embodiment of the present invention, it is possible to measure acoustic characteristics of a parametric speaker having any shape and characteristics. Specifically, it is possible to calculate the sound pressure at a point in the sound field generated by the radiated sound of the parametric speaker.

### Supplementary Notes

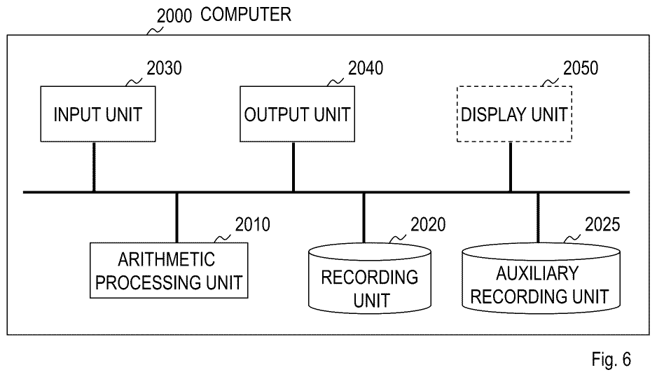

Processing of each unit of each device described above may be implemented by a computer, and in this case, processing details of a function that each device should have are written by a program. Then, by causing a recording unit 2020 of a computer 2000 illustrated in FIG. 6 to read this program and causing an arithmetic processing unit 2010, an input unit 2030, an output unit 2040, an auxiliary recording unit 2025, and the like to operate, processing functions in each device described above are implemented on the computer.

The device according to the present invention includes, for example, as a single hardware entity, an input unit that can receive input of a signal from the outside of the hardware entity, an output unit that can output a signal to the outside of the hardware entity, a communication unit to which a communication device (for example, a communication cable) capable of communicating with the outside of the hardware entity can be connected, a CPU (Central Processing Unit, which may include a cache memory, a register, and the like) which is an arithmetic processing unit, a RAM and a ROM which are memories, an external storage device which is a hard disk, and a bus connected such that the input unit, the output unit, the communication unit, the CPU, the RAM, the ROM, and the external storage device can exchange data. Furthermore, if necessary, a device (drive) or the like that can read and write a recording medium such as a CD-ROM may be provided in the hardware entity. Examples of a physical entity including such a hardware resource include a general-purpose computer.

The external storage device of the hardware entity stores a program that is required for implementing the functions described above, data that is required for processing of the program, and the like (the program may be stored, for example, in a ROM as a read-only storage device instead of the external storage device). Moreover, data obtained by processing of the program is appropriately stored in a RAM or an external storage device.

In the hardware entity, each program stored in the external storage device (or the ROM or the like) and data required for processing of each program are loaded into a memory as necessary, and are appropriately interpreted, executed, and processed by the CPU. As a result, the CPU implements a predetermined function (each component represented as the above . . . unit, . . . means, and the like). That is, each of the components of the embodiment of the present invention may include processing circuitry.

As described earlier, in a case where the processing functions of the hardware entity (the device according to the present invention) described in the foregoing embodiments are implemented by a computer, processing details of the functions that the hardware entity are supposed to have are described by a program. The computer then executes this program, whereby the processing functions of the hardware entity are implemented in the computer.

The program in which the processing details are written can be recorded on a computer-readable recording medium. The computer-readable recording medium is, for example, a non-transitory recording medium and is specifically a magnetic recording device, an optical disc, or the like.

Furthermore, the distribution of the program is performed by, for example, selling, transferring, or rending a portable recording medium such as a DVD or a CD-ROM in which the program is recorded. Moreover, the program may be stored in a storage device of a server computer, and the program may be distributed by transferring the program from the server computer to another computer via a network.

For example, the computer that executes such a program first temporarily stores the program recorded in the portable recording medium or the program transferred from the server computer in the auxiliary recording unit 2025 as the own non-transitory storage device of the computer. Then, at the time of executing processing, this computer reads the program stored in the auxiliary recording unit 2025 as the own non-transitory storage device of the computer into the recording unit 2020 and executes processing in accordance with the read program. As another mode of executing this program, the computer may directly read the program from the portable recording medium into the recording unit 2020 and execute processing in accordance with the read program, or alternatively, each time the program is transferred to this computer from the server computer, the computer may sequentially execute processing in accordance with the received program. In addition, the above-described processing may be executed by a so-called ASP (Application Service Provider) type service that implements a processing function only by an execution instruction and result acquisition without transferring the program from the server computer to the computer. Note that the program in the present embodiment includes information used for processing by an electronic computer and equivalent to the program (data which is not a direct command to the computer but has property that defines processing of the computer).

Moreover, although the present device is configured by the predetermined program being executed on the computer in this mode, at least a part of the processing details may be implemented by hardware.

The present invention is not limited to the embodiment described above, and can be appropriately modified without departing from the gist of the present invention.

1. An acoustic characteristics calculation device comprising:
wherein Q is an integer equal to or greater than 2 and L_{q} (q=1, 2, . . . , Q) is an optical path in q-th measurement by an optical measurement device that measures a phase change of light due to radiated sound of a parametric speaker that is an object of acoustic characteristics measurement, and
a measurement data acquisition circuitry configured to acquire a set of a phase change amount φ_{q} of light due to the radiated sound of the parametric speaker obtained in the q-th measurement by the optical measurement device and a parameter ρ_{q} that characterizes the optical path L_{q} in the measurement (q=1, 2, . . . , Q); and
a sound field calculation circuitry configured to calculate a sound pressure at a point in a sound field that is generated by the radiated sound of the parametric speaker from the set of the phase change amount φ_{q} and the parameter ρ_{q} (q=1, 2, . . . , Q).

2. The acoustic characteristics calculation device according to claim 1, wherein the sound field calculation circuitry includes:
a line integral value calculation circuitry configured to calculate a line integral value d_{q} (q=1, 2, . . . , Q) of a sound pressure in a frequency domain along the optical path L_{q} from the phase change amount φ_{q} (q=1, 2, . . . , Q);
an expansion coefficient calculation circuitry configured to calculate an optimal value αₛ* (s=1, 2, . . . , S) of an expansion coefficient as in an expansion equation of a sound pressure u in a frequency domain in the following equations, from a set of the line integral value d_{q} and the parameter ρ_{q} (q=1, 2, . . . , Q),
$$u ( x ) = {\int }_{{S}^{2}} g ( v ) {e}^{ik < x , v >} dv \qquad [ Math . 31 ]$$
$$g = {\sum }_{s = 1}^{S} {α}_{s} {Y}_{s} \qquad [ Math . 32 ]$$
(where S² represents a unit sphere, i represents an imaginary unit, <a, b> represents an inner product of vector a and vector b, k represents a wave number, and Yₛ (s=1, . . . , S) is a sequence of functions obtained by arranging S spherical harmonic functions Yₙ^{m} (n=0, 1, . . . , m=−n, −n−2, . . . , n−2, n) in ascending order of n); and
a sound pressure calculation circuitry configured to calculate a sound pressure u(x) at a point x in the sound field according to the expansion equation using the optimal value αₛ* (s=1, 2, . . . , S).

3. The acoustic characteristics calculation device according to claim 1, wherein the sound field calculation circuitry includes:
a line integral value calculation circuitry configured to calculate a line integral value σ_{q} (q=1, 2, . . . , Q) of a sound pressure in a time domain along the optical path L_{q} from the phase change amount φ_{q} (q=1, 2, . . . , Q);
an expansion coefficient calculation circuitry configured to calculate an optimal value aₛ* (s=1, 2, . . . , S) of an expansion coefficient as in an expansion equation of a line integral value σ of a sound pressure in a time domain in the following equation, from a set of the line integral value σ_{q} and the parameter ρ_{q} (q=1, 2, . . . , Q),
$$σ = {\sum }_{s = 1}^{S} {a}_{s} {\int }_{L} {e}^{i < {k}_{s} , x >} dx \qquad [ Math . 33 ]$$
(where L represents an optical path in measurement, i represents an imaginary unit, <a, b> represents an inner product of vector a and vector b, and kₛ represents a wave number vector indicating a propagation direction of an s-th wave); and
a sound pressure calculation circuitry configured to calculate sound pressures p₁, p₂, . . . , p_{J} at points x₁, x₂, . . . , x_{J} in the sound field by the following equation using the optimal value aₛ* (s=1, 2, . . . , S),
$$\tilde{p} = G \tilde{a} \qquad [ Math . 34 ]$$
(where ~p represents a J-dimensional column vector with p_{J} (j=1, 2, . . . , J) as its j-th element, G represents a J×S matrix with g_{j,s} (j=1, 2, . . . , J, s=1, 2, . . . , S) as its (j, s)-th element in the following equation, and ~a represents an S-dimensional column vector with aₛ* (s=1, 2, . . . , S) as its s-th element).
$${g}_{j , s} = {e}^{i < {k}_{s} , {x}_{j} >} \qquad [ Math . 35 ]$$

4. An acoustic characteristics calculation method comprising:
wherein Q is an integer equal to or greater than 2 and L_{q} (q=1, 2, . . . , Q) is an optical path in q-th measurement by an optical measurement device that measures a phase change of light due to radiated sound of a parametric speaker that is an object of acoustic characteristics measurement, and
acquiring a set of a phase change amount φ_{q} of light due to the radiated sound of the parametric speaker obtained in the q-th measurement by the optical measurement device and a parameter ρ_{q} that characterizes the optical path L_{q} in the measurement (q=1, 2, . . . , Q); and
calculating a sound pressure at a point in a sound field that is generated by the radiated sound of the parametric speaker from the set of the phase change amount φ_{q} and the parameter ρ_{q} (q=1, 2, . . . , Q).

5. A non-transitory computer-readable storage medium which stores a program for causing a computer to perform the acoustic characteristics calculation method according to claim 4.
